(19) United States
(12) Patent Application Publication
(10) Pub. No.: US 2014/0376873 A1
(43) Pub. Date: Dec. 25, 2014

(54) VIDEO-AUDIO PROCESSING DEVICE AND VIDEO-AUDIO PROCESSING METHOD

(71) Applicant: PANASONIC CORPORATION, Osaka (JP)

(72) Inventors: Shunsuke Tanaka, Osaka (JP); Takeshi Yamada, Osaka (JP)

(21) Appl. No.: 14/376,575

(22) PCT Filed: Nov. 29, 2012
(86) PCT No.: PCT/JP2012/007669

§ 371 Date: Aug. 4, 2014

(30) Foreign Application Priority Data
Mar. 8, 2012 (JP) 2012-051943

(51) Int. Cl. G11B 27/10; H04N 21/472; G11B 27/00; H04N 21/43; H04W 4/00; G11B 31/00

(52) U.S. Cl. CPC G11B 27/10; H04W 4/008; G11B 31/006; G11B 27/005; H04N 21/4307; H04N 21/472
USPC 386/203

(57) ABSTRACT

A video-audio processing device including a video output unit, an audio output unit, an audio transmitting unit, a controlling unit which switches an operation mode between (a) a first mode in which the audio signal is outputted from the audio output unit and the audio signal is transmitted from the audio transmitting unit and (b) a second mode in which the video signal is outputted from the video output unit and the audio signal is transmitted from the audio transmitting unit, a receiving unit which receives an input of delay information indicating an audio delay amount during the first mode, an audio delaying unit which delays the audio signal according to the audio delay amount, and a video delaying unit which delays the video signal by a video delay amount that is in accordance with the audio delay amount during the second mode.

### TECHNICAL FIELD

The present invention relates to video-audio processing devices, and particularly to a video-audio processing device which performs synchronization between a video signal and an audio signal in reproduction.

### BACKGROUND ART

Conventionally, video-audio processing devices which process and output a video signal and an audio signal are available. Such a video-audio processing device may separately provide the video signal and the audio signal to different apparatuses and each of the apparatuses reproduces the video or the audio, for example. In this case, synchronization between the video signal and the audio signal in reproduction (for example, referred to as “lip-sync”) emerges as a problem.

In view of this, techniques for synchronizing the video signal and the audio signal in reproduction are disclosed. For example, Patent Literature (PTL) 1 discloses an audio-video transmission device which reduces a delay between reproduced video and reproduced audio by delaying the audio signal.

### CITATION LIST

### Patent Literature

[PTL 1] Japanese Unexamined Patent Application Publication No. 2004-88442

### SUMMARY OF INVENTION

### Technical Problem

Here, it is assumed, for example, that a broadcast program is displayed on a television display and an audio signal of the broadcast program transmitted from the television is received and reproduced by an external apparatus (an external speaker, a headphone, etc.) of the television. In this case, the audio signal reproduced by the external apparatus may be behind a video signal displayed on the display.

The present disclosure provides a video-audio processing device which is capable of efficiently performing synchronization between a video signal and an audio signal in reproduction.

### Solution to Problem

In order to achieve the aforementioned object, the video-audio processing device according to an aspect of the present disclosure includes: a video output unit which outputs a video signal; an audio output unit which outputs an audio signal corresponding to the video signal; an audio transmitting unit which transmits the audio signal corresponding to the video signal to an external audio reproduction device provided outside the video-audio processing device; a controlling unit which switches an operation mode of the video-audio processing device between (a) a first mode in which the audio signal is outputted from the audio output unit and the audio signal is transmitted from the audio transmitting unit and (b) a second mode in which the video signal is outputted from the video output unit and the audio signal is transmitted from the audio transmitting unit; a receiving unit which receives an input of delay information indicating an audio delay amount which is an amount for delaying an output of the audio signal from the audio output unit, during a period in which the operation mode is the first mode; an audio delaying unit which delays the output of the audio signal from the audio output unit according to the audio delay amount indicated by the delay information received by the receiving unit; and a video delaying unit which delays an output of the video signal from the video output unit by a video delay amount that is in accordance with the audio delay amount, during a period in which the operation mode is the second mode.

These general and specific aspects may be implemented using a system, a method, an integrated circuit, a computer program, or a recording medium, or any combination of systems, methods, integrated circuits, computer programs, or recording media.

### Advantageous Effects of Invention

According to the video-audio processing device in the present disclosure, synchronization between a video signal and an audio signal in reproduction can be efficiently performed.

### BRIEF DESCRIPTION OF DRAWINGS

FIG. 1 is a diagram showing a schematic configuration of an audio visual (AV) system according to an embodiment.

FIG. 2 is a block diagram showing a basic functional configuration of the AV system according to the embodiment.

FIG. 3 is a flow chart showing basic processing performed by a video-audio processing device according to the embodiment.

FIG. 4 is a diagram showing an example of a user interface screen outputted by the video-audio processing device according to the embodiment.

FIG. 5 is a diagram illustrating synchronization adjustment between a video signal and an audio signal performed by the video-audio processing device according to the embodiment.

FIG. 6 is a diagram showing a relationship of one frame time period and an amount of delay between audio output timings of a speaker and a headphone.

FIG. 7 is a block diagram showing a basic functional configuration of the video-audio processing device according to the embodiment in the case where the video-audio processing device includes a storing unit.

FIG. 8 is a diagram showing a schematic configuration of the AV system according to the embodiment in the case where the AV system includes plural audio reproduction devices.

FIG. 9 is a diagram showing an example of a data configuration of video delay information according to the embodiment.

FIG. 10 is a block diagram showing a basic functional configuration of the video-audio processing device according to the embodiment in the case where the video-audio processing device obtains a reproduced audio signal as delay information.

### DESCRIPTION OF EMBODIMENT

(Underlying Knowledge Forming Basis of the Present Invention)

The inventors have found that following problems arise with respect to synchronization between a video signal and an audio signal in reproduction.

For example, a broadcast program in digital television broadcasting is transmitted to a television in the form of a stream including a video signal and an audio signal corresponding to the broadcast program and a signal for synchronizing the video signal and the audio signal. Therefore, the problem in lip-sync does not generally occur when the broadcast program is reproduced by a lone television.

However, as described above for example, in the case where the audio signal transmitted from the television is received and reproduced by an external apparatus (an audio reproduction device) while the video signal is reproduced on the television, the audio reproduced by the audio reproduction device may be behind the video reproduced by the television.

This delay is caused by, for example, communication procedure between the television and the audio reproduction device (retransmission of the audio signal at the time of a communication error) or processing of the audio signal in the audio reproduction device (buffering of the audio signal for preventing intermittent interruption of sound).

When the reproduced audio is behind the reproduced video as above, it is unrealistic and difficult to make an early output of the audio in view of the above-mentioned cause of the delay.

Therefore, timings for reproducing the video and the audio may be matched by delaying reproduction of the video. That is, the video signal and the audio signal may be synchronized in reproduction by delaying an output of the video signal in a video-audio processing device which outputs the video signal to a display and transmits the audio signal to the external audio reproduction device.

However, in this case, a user needs to input an amount of delay of the video signal into the video-audio processing device so as to delay the reproduction of the video while listening to the audio reproduced by the audio reproduction device, for example.

For example, the user adjusts the amount of delay of the video signal while listening to a voice of a person reproduced by the audio reproduction device and so as to match the voice and the movement of the lip of the person in the reproduced video on the television.

That is, a difficult operation to try to match, on a time series, a characteristic point of the audio obtained by auditory perception and a characteristic point of the video obtained by visual perception by simultaneously using the auditory perception and the visual perception.

As a result, in the video-audio processing device, an increase and a decrease in the amount of delay are repeated until the user does not feel discomfort about the audio and the video obtained by the auditory perception and the visual perception, which is inefficient processing.

Furthermore, when the audio reproduction device which receives and reproduces the audio signal is replaced, the amount of delay also changes. As a result, there arises a problem that inefficient processing is needed every time the audio reproduction device is replaced.

In order to solve the aforementioned problems, the video-audio processing device according to an aspect of the present disclosure includes: a video output unit which outputs a video signal; an audio output unit which outputs an audio signal corresponding to the video signal; an audio transmitting unit which transmits the audio signal corresponding to the video signal to an external audio reproduction device provided outside the video-audio processing device; a controlling unit which switches an operation mode of the video-audio processing device between (a) a first mode in which the audio signal is outputted from the audio output unit and the audio signal is transmitted from the audio transmitting unit and (b) a second mode in which the video signal is outputted from the video output unit and the audio signal is transmitted from the audio transmitting unit; a receiving unit which receives an input of delay information indicating an audio delay amount which is an amount for delaying an output of the audio signal from the audio output unit, during a period in which the operation mode is the first mode; an audio delaying unit which delays the output of the audio signal from the audio output unit according to the audio delay amount indicated by the delay information received by the receiving unit; and a video delaying unit which delays an output of the video signal from the video output unit by a video delay amount that is in accordance with the audio delay amount, during a period in which the operation mode is the second mode.

With this configuration, it is possible to input, to the video-audio processing device, delay information obtained from a result of a comparison between audio from a speaker connected to the audio output unit and audio from the external audio reproduction device, for example. Here, the audio is outputted while the video-audio processing device is in operation in the first mode.

That is, the delay information for indicating an amount of delay (an audio delay amount) between the audio based on the audio signal which is outputted from the audio output unit and has no problem in synchronization with the video signal (first audio) and the audio from the external audio reproduction device (second audio) is inputted to the video-audio processing device. Furthermore, the video signal is delayed according to the audio delay amount.

To put it shortly, the amount of delay between the second audio from the external audio reproduction device and the video displayed on the display connected to the video output unit is determined not based on a comparison between the second audio and the video, but based on a comparison between the second audio and the first audio which is reliably synchronized with the video.

Here, a human has characteristics that an ability to perceive a temporal delay is high. This is because of a use of time difference between two sounds which are generated at an audio source and arrive at both ears at a slight interval, in order to identify the position of the audio source, etc. Therefore, it is possible to match the first audio and the second audio highly accurately. As a result, even when a human performs the above comparison, it is easy to delay the first audio so as to match the timings of the first audio and the second audio.

Thus, a determination of the audio delay amount for synchronizing the first audio and the second audio is facilitated. As a result, a determination of the video delay amount for synchronizing the second audio and the video that is based on the video signal is also facilitated.

As a matter of course, even when the audio delay amount is determined not by the human but mechanically, the determination is facilitated by, for example, comparing timings of peaks of sound pressure levels of the first audio and the second audio. That is, the audio delay amount is determined without complicated processing such as a comparison between a result of an audio analysis and a video analysis. As a result, the determination of the video delay amount for synchronizing the second audio and the video based on the video signal is also facilitated.

As described above, the video-audio processing device according to the present aspect is capable of efficiently determining the video delay amount for synchronizing the video signal and the audio signal in reproduction, and therefore, is capable of efficiently performing processing for the synchronization.

Moreover, for example, the video output unit outputs a video signal representing a user interface screen for a predetermined operation by a user, during a period in which the operation mode is the first mode, and the receiving unit receives an input of the delay information inputted through the predetermined operation by the user.

With this configuration, the video-audio processing device is capable of enabling the user, for example, an efficient adjusting operation for lip-sync.

Moreover, for example, the video delaying unit delays the output of the video signal from the video output unit by the video delay amount which is smaller than or equal to the audio delay amount.

With this configuration, although the video delay amount may be smaller than an exact amount of delay for the lip-sync, at least, it is possible to prevent the audio from preceding the video. For example, in video in which a person is talking, a very unnatural situation in which the speech is reproduced by the external audio reproduction device before the person moves his/her mouth is prevented.

Moreover, for example, the audio delaying unit delays the output of the audio signal from the audio output unit according to the audio delay amount which corresponds to an integral multiple of a time period for one frame calculated from a frame rate of the video signal.

With this configuration, for example, when the video is delayed on a per frame basis, the audio delay amount can be used as the video delay amount without any processing. Thus, a processing load for the synchronization between the video signal and the audio signal is reduced.

Moreover, for example, the video delaying unit delays the output of the video signal from the video output unit by the video delay amount which is larger than the audio delay amount, and the audio transmitting unit delays transmission of the audio signal from the audio transmitting unit by a value corresponding to a difference between the audio delay amount and the video delay amount.

With this configuration, the following effect is obtained. For example, in the case where the video delay amount is determined as an integral multiple of a constant, it may be impossible to match the video delay amount with the audio delay amount even when the audio delay amount can be equated with an exact amount of delay.

Even in such a case, the same advantage can be obtained as the case where the video delay amount is brought close to the exact amount of delay by determining the video delay amount to be larger than the audio delay amount and delaying transmission of the audio signal from the audio transmitting unit. That is, the accuracy of lip-sync is improved.

Moreover, for example, the video delaying unit delays the output of the video signal from the video output unit by the video delay amount which is smaller than or equal to the audio delay amount and corresponds to an integral multiple of a time period for one frame calculated from a frame rate of the video signal.

With this configuration, since the video delay amount is determined according to the frame rate of the video signal, the delay processing for the video signal is performed on a per frame basis. As a result, complication of the delay processing is reduced.

Moreover, for example, the receiving unit receives, as the delay information, an input of a reproduced audio signal which is an audio signal outputted from the external audio reproduction device which receives and reproduces the audio signal, and the video delaying unit delays the output of the video signal from the video output unit by the video delay amount that is in accordance with the audio delay amount which is an amount of delay between the reproduced audio signal and the audio signal that has not yet been delayed by the audio delaying unit.

With this configuration, the reproduced audio signal obtained from the external audio reproduction device is used as the delay information. Therefore, for example, the lip-sync can be automated by the video-audio processing device.

Moreover, for example, the video-audio processing device according to an aspect of the present disclosure further includes: a storing unit which stores therein video delay information which is information indicating the video delay amount, in which the video delaying unit delays the output of the video signal from the video output unit by the video delay amount indicated by the video delay information read from the storing unit, during a period in which the operation mode is the second mode.

With this configuration, the determined video delay amount is stored in the video-audio processing device. Therefore, for example, in the case where there are plural audio reproduction devices to which the audio signal is transmitted from the video-audio processing device, the video delay amounts respectively corresponding to the audio reproduction devices can be stored in the storing unit.

As a result, even when the audio reproduction device to which the audio signal is transmitted is replaced, the video-audio processing device can perform the delay processing on the video signal using an appropriate video delay amount.

Moreover, for example, the storing unit stores therein the video delay information indicating plural video delay amounts respectively corresponding to plural audio reproduction devices including the audio reproduction device, and when the operation mode is the second mode and the audio transmitting unit simultaneously transmits the audio signal to each of the audio reproduction devices, the video delaying unit (c) selects the largest video delay amount among the video delay amounts indicated by the video delay information stored in the storing unit and (d) delays the output of the video signal from the video output unit by the selected video delay amount.

With this configuration, the following effect is obtained. For example, it is assumed that plural users listen to audio with respectively-worn headphones which perform wireless-communication with the video-audio processing device, while watching video on a single display connected to the video output unit.

In this case, since the audio delay amount is different in each headphone, the video delay amount corresponding to each headphone is also different. In this regard, the video signal is delayed according to the maximum value among the video delay amounts. That is, at least, a very unnatural situation is not likely to occur in which the reproduced audio from each headphone precedes the video on the display.

These general and specific aspects may be implemented using a system, a method, an integrated circuit, a computer program, or a recording medium, or any combination of systems, methods, integrated circuits, computer programs, or recording media.

### Embodiment

Hereinafter, a video-audio processing device according to an embodiment will be described with reference to the drawings. It is to be noted that the diagrams are schematic diagrams, and the illustrations are not necessarily strictly accurate.

It is to be noted that the embodiment described below shows a general or specific example of the present disclosure. Therefore, the numerical values, shapes, materials, constituent elements, the arrangement and connection of the constituent elements, steps, the processing order of the steps etc. shown in the following exemplary embodiment are mere examples, and therefore do not limit the scope of the present disclosure. Moreover, among the constituent elements in the following embodiment, constituent elements not recited in any one of the independent claims are described as optional constituent elements.

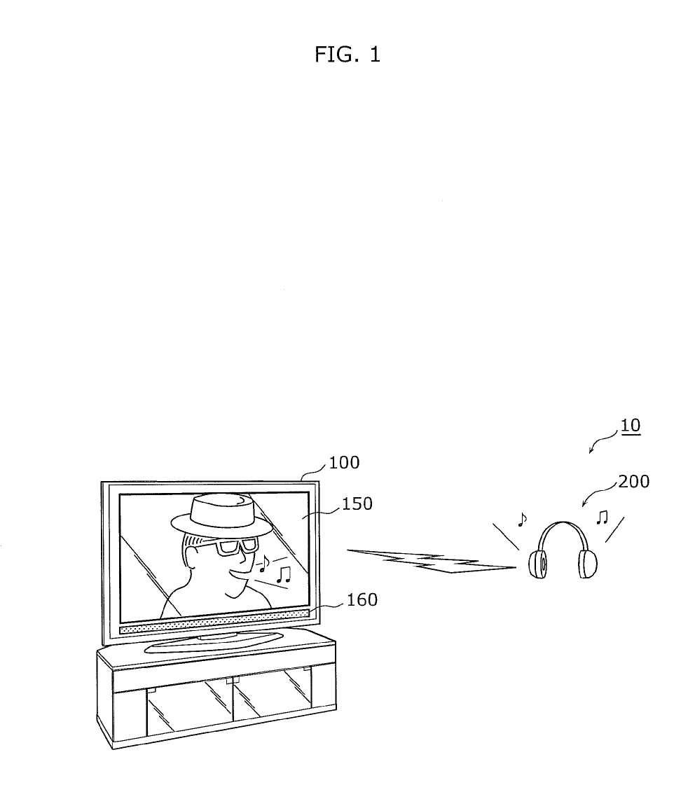

FIG. 1 is a diagram showing a schematic configuration of an audio visual (AV) system 10 according to the embodiment.

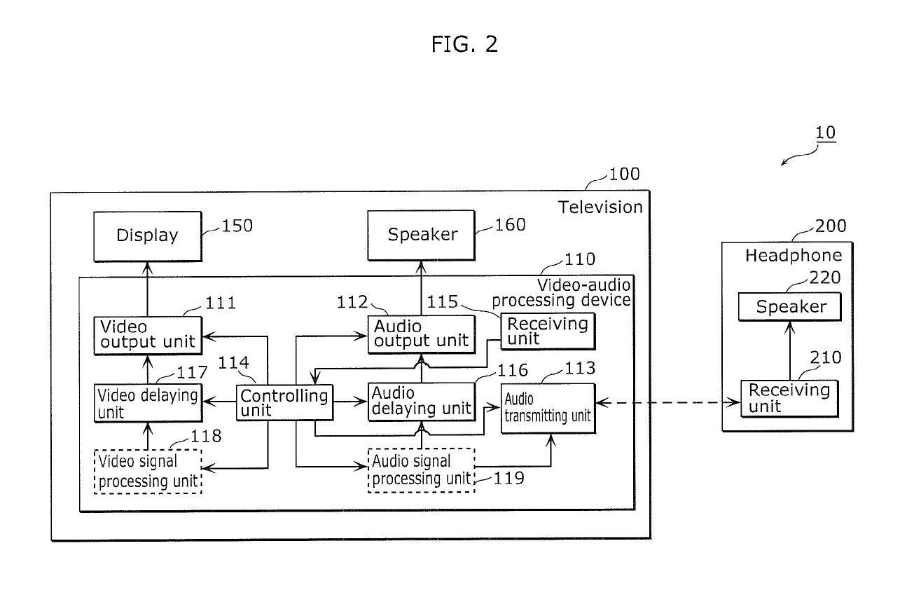

FIG. 2 is a block diagram showing a basic functional configuration of the AV system 10 according to the embodiment.

As shown in FIG. 1, the AV system 10 according to the embodiment includes a television 100 and a headphone 200.

The television 100 is a device which receives and reproduces AV content such as a broadcast program and includes a video-audio processing device 110, a display 150, and a speaker 160.

The headphone 200 is an example of an external audio reproduction device provided outside the video-audio processing device 110. The headphone 200 includes, as shown in FIG. 2, a receiving unit 210 which receives an audio signal transmitted from the video-audio processing device 110 and a speaker 220 which outputs reproduced audio of the audio signal received by the receiving unit 210.

It is to be noted that the headphone 200 includes two speakers 220 for a right ear and a left ear. However, in FIG. 2, one of the speakers 220 is not shown.

A user can watch video of the AV content on the display 150 of the television 100 while listening to audio of the AV content through the headphone 200.

It is to be noted that Bluetooth (registered trademark), for example, is employed as a communication standard between the video-audio processing device 110 and the headphone 200.

The video-audio processing device 110 includes, as shown in FIG. 2, a video output unit 111, an audio output unit 112, an audio transmitting unit 113, a controlling unit 114, a receiving unit 115, an audio delaying unit 116, a video delaying unit 117, a video signal processing unit 118, and an audio signal processing unit 119.

The video output unit 111 outputs a video signal. In this embodiment, the video output unit 111 provides the video signal obtained from the video signal processing unit 118 via the video delaying unit 117 to the display 150. As a result, video based on the video signal is displayed on the display 150.

The audio output unit 112 outputs an audio signal corresponding to the video signal. In this embodiment, the audio output unit 112 provides the audio signal obtained from the audio signal processing unit 119 via the audio delaying unit 116 to the speaker 160. As a result, audio based on the audio signal, that is, audio corresponding to the video displayed on the display 150 is outputted from the speaker 160.

The audio transmitting unit 113 transmits the audio signal corresponding to the video signal to the headphone 200 which is the external audio reproduction device provided outside the video-audio processing device 110.

In this embodiment, the audio transmitting unit 113 transmits the audio signal obtained from the audio signal processing unit 119 to the headphone 200. As a result, audio based on the audio signal is outputted from the headphone 200.

Specifically, in the headphone 200, the receiving unit 210 receives the audio signal transmitted from the audio transmitting unit 113 and a predetermined processing for reproducing audio is performed. With this, audio corresponding to the video displayed on the display 150 is outputted from the speaker 220 included in the headphone 200.

The controlling unit 114 switches an operation mode of the video-audio processing device 110 between an adjustment mode and a viewing and listening mode. Moreover, the controlling unit 114 also controls constituent elements of the video-audio processing device 110 such as the video output unit 111.

It is to be noted that the adjustment mode is an example of a first mode which is an operation mode in which the audio signal is outputted from the audio output unit 112 and the audio signal is transmitted from the audio transmitting unit 113. Specifically, the adjustment mode is an operation mode in which an adjustment for lip-sync (hereinafter referred to as “synchronization adjustment”) is performed.

Moreover, the viewing and listening mode is an example of a second mode which is an operation mode in which the video signal is outputted from the video output unit 111 and the audio signal is transmitted from the audio transmitting unit 113. That is, the viewing and listening mode is an operation mode in which the user watches the video displayed on the display 150 while listening to the audio corresponding to the video with the headphone 200.

In this embodiment, an audio output from the speaker 160 is stopped in the viewing and listening mode.

It is to be noted that the video-audio processing device 110 also operates in a normal operation mode (normal mode) in which the user views and listens to the AV content by means of the display 150 and the speaker 160. However, since the normal mode is a general operation mode as the television 100, the description thereof is omitted.

The receiving unit 115 receives an input of delay information which indicates an audio delay amount which is an amount for delaying an output of the audio signal from the audio output unit 112, during a time period in which the operation mode is the adjustment mode.

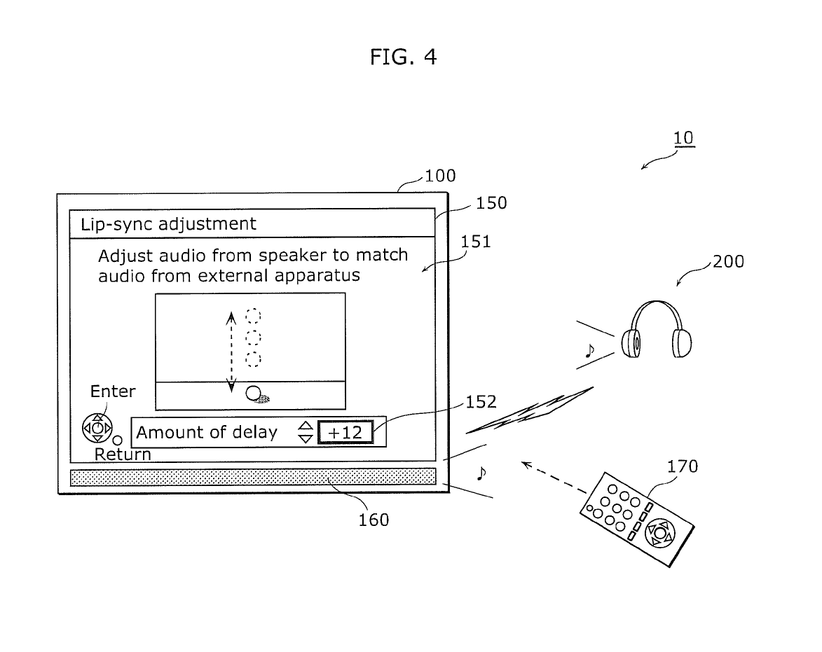

In this embodiment, a user interface screen for entering the delay information is displayed on the display 150 in the adjustment mode. The user interface screen will be described later with reference to FIG. 4.

The audio delaying unit 116 delays an output of the audio signal from the audio output unit 112 according to the audio delay amount indicated by the delay information received by the receiving unit 115. That is, the audio output from the speaker 160 is delayed according to the audio delay amount.

The video delaying unit 117 delays an output of the video signal from the video output unit 111 by the video delay amount corresponding to the audio delay amount during the period in which the operation mode is the viewing and listening mode. That is, the video to be displayed on the display 150 is delayed according to the audio delay amount determined in the adjustment mode.

With the above configuration, the video-audio processing device 110 according to this embodiment is capable of efficiently performing processing for lip-sync, that is, synchronization between the video signal and the audio signal in reproduction.

Specifically, in this embodiment, Bluetooth (registered trademark) is employed as a communication standard for transmitting the audio signal as described above.

Moreover, in the headphone 200, buffering of the audio signal is performed (a buffer is not shown in FIG. 2). Therefore, in the headphone 200, the audio signal which should be reproduced by the headphone 200 is reproduced without interruption.

However, due to processing such as buffering of the audio signal, the audio from the headphone 200 may be reproduced later than the original reproduction timing. As a result, a delay can be generated between the reproduced video on the display 150 and the reproduced audio from the headphone 200.

In this regard, the video-audio processing device 110 according to this embodiment can efficiently perform synchronization between the reproduced video on the display 150 and the reproduced audio from the headphone 200 through the processing performed by the audio delaying unit 116 and the video delaying unit 117.

It is to be noted that, in this embodiment, the video signal processing unit 118 obtains the video signal from a stream received from a tuner (not shown) included in the television 100 and provides the video signal to the video delaying unit 117. Moreover, the audio signal processing unit 119 obtains the audio signal from the stream and provides the audio signal to the audio delaying unit 116.

That is, the video signal processing unit 118 and the audio signal processing unit 119 are devices for providing the video-audio processing device 110 with signals which are a source of video and audio reproduced by the television 100, and may be placed outside the video-audio processing device 110. In other words, the video signal processing unit 118 and the audio signal processing unit 119 are not essential element of the video-audio processing device 110.

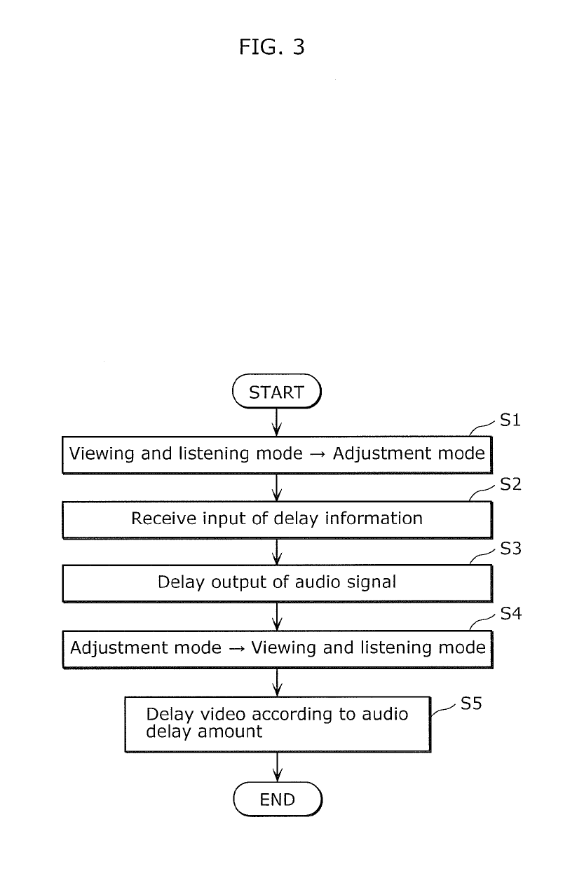

Hereinafter, processing performed by the video-audio processing device 110 according to this embodiment is described with reference to FIGS. 3 to 6.

FIG. 3 is a flow chart showing basic processing performed by the video-audio processing device 110 according to the embodiment.

The controlling unit 114 switches the operation mode of the video-audio processing device 110 from the viewing and listening mode to the adjustment mode in response to, for example, an instruction from the user (S1).

During the period in which the operation mode is the adjustment mode, the receiving unit 115 receives an input of the delay information through a predetermined operation by the user (S2). For example, “200 milliseconds (msec)” that is the audio delay amount itself or “+12,” etc. that is a numerical value showing the magnitude of the audio delay amount is inputted as the delay information.

The audio delaying unit 116 delays the output of the audio signal from the audio output unit 112 according to the audio delay amount indicated by the delay information (S3).

Subsequently, in response to an instruction from the user, for example, the controlling unit 114 switches the operation mode of the video-audio processing device 110 from the adjustment mode to the viewing and listening mode after the determination of the audio delay amount (S4).

The video delaying unit 117 delays the output of the video signal from the video output unit 111 by the video delay amount corresponding to the audio delay amount during the period in which the operation mode is the viewing and listening mode (S5).

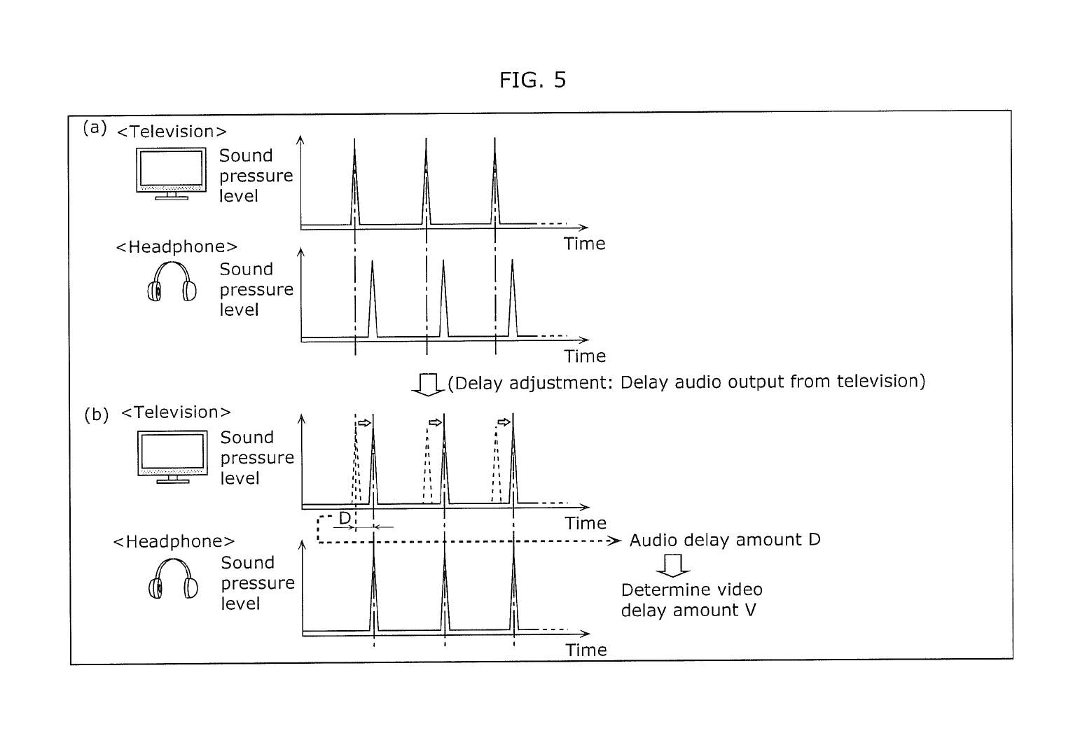

Specific operations of the video-audio processing device 110 which performs the above processing are described with reference to FIGS. 4 to 5.

FIG. 4 is a diagram showing an example of a user interface screen 151 outputted by the video-audio processing device 110 according to the embodiment.

FIG. 5 is a diagram illustrating synchronization adjustment performed by the video-audio processing device 110 according to the embodiment.

The video-audio processing device 110 outputs the user interface screen 151 as shown in FIG. 4 to the display 150 when operating in the adjustment mode.

Moreover, in the adjustment mode, pulsed sounds are outputted, for example, at predetermined intervals (for example, every 1 to 2 seconds) from both of the speaker 160 and the headphone 200 as audio used for the synchronization adjustment.

Moreover, in synchronization with the pulsed sound outputted at the predetermined intervals from the speaker 160, for example, video in which a ball bounds on a floor to perform a simple harmonic motion as shown in FIG. 5 is displayed on the user interface screen 151. Specifically, at a time when the ball touches the floor, a pulsed sound is outputted from the speaker 160.

Moreover, when the synchronization adjustment is not completed, a time of outputting audio from the headphone 200 is behind a time of outputting audio from the speaker 160 as shown in (a) in FIG. 5.

Thus, the user notices a temporal delay between sounds perceived by a right ear and a left ear, for example, when listening to the audio from the headphone 200 with one ear and listening to the audio from the speaker 160 with the other ear.

In such a situation, the delay information is inputted to the video-audio processing device 110, for example, through an operation by the user on an arrow key of a remote controller 170 for the television 100.

In the example shown in FIG. 4, a set value “+12” is displayed in a set value display field 152 on the user interface screen 151 as the delay information indicating the audio delay amount. This set value is changed, for example, through an operation by the user on the arrow key of the remote controller 170. Furthermore, the set value is received by the receiving unit 115 as the delay information.

Specifically, a value obtained by multiplying a unit delay amount d by the set value which is a positive integer is used as the audio delay amount. The unit delay amount d is, for example, a time period of one frame (hereinafter referred to as “one frame time period”) calculated from a frame rate of the video signal to be outputted from the video output unit 111.

For example, when the frame rate is 60 frames/sec., the unit delay amount d is (50/3 (=16.66666 . . . )) msec which is one frame time period. Therefore, when the set value is “12”, 200 msec which is obtained by multiplying (50/3) msec by 12 is determined as the audio delay amount. It is to be noted that this calculation is performed by, for example, the receiving unit 115, the controlling unit 114, or the audio delaying unit 116.

The audio delaying unit 116 delays the audio signal received from the audio signal processing unit 119, according to the audio delay amount obtained in such a way. As a result, the output of the audio signal from the audio output unit 112 is delayed.

For example, when the unit of the delay performed by the audio delaying unit 116 is 0.1 msec, the output of the audio signal from the audio output unit 112 is delayed by 200.0 msec. It is to be noted that the audio delay amount and an actual amount of audio delay need not precisely match. For example, when the unit of the delay performed by the audio delaying unit 116 is 3 msec, the actual amount of audio delay may be 201 msec.

As described above, the output of the audio signal from the audio output unit 112 is delayed according to the delay information (set value) inputted by the user, and consequently, an audio output from the speaker 160 is delayed.

Thus, the user can change the set value so as to minimize a temporal delay between the audio from the speaker 160 and the audio from the headphone 200.

As a result, as shown in (b) in FIG. 5, an audio delay amount D which allows the temporal delay to be the smallest in terms of the user's perception is determined. For example, in the case where the set value is “+12”, the set value “+12” is determined as the delay information for the synchronization adjustment when the user presses a predetermined button of the remote controller 170. That is, “200 msec” corresponding to the set value “+12” is determined as the audio delay amount D.

Moreover, the output of the audio signal from the audio output unit 112 is delayed by the audio delay amount D which has been determined as above. Thus, as shown in (b) in FIG. 5, a time of an audio output from the headphone 200 and a time of an audio output from the speaker 160 match (including approximately match, and the same shall apply hereafter). That is, the audio signals are synchronized between the headphone 200 and the speaker 160.

The controlling unit 114 obtains the audio delay amount D which has been determined as above and transmits the obtained audio delay amount D to the video delaying unit 117.

The video delaying unit 117 determines the video delay amount V according to the received audio delay amount D and delays the video signal received from the video signal processing unit 118 by the video delay amount V. As a result, the output of the video signal from the video output unit 111 is delayed by the video delay amount V.

Here, as described above, when the unit delay amount d is one frame time period for the video signal, that is, when the audio delay amount D is an integral multiple of the one frame time period, the audio delay amount D is used as the video delay amount V as it is.

For example, when the audio delay amount D is “200 msec”, the video delay amount V is also determined to be “200 msec”.

In this case, the video delaying unit 117 receives the video signal from the video signal processing unit 118, delays the received video signal by 12 frames, and provides the delayed video signal to the video output unit 111. As a result, the output of the video signal from the video output unit 111 to the display 150 is delayed by “200 msec” which is the video delay amount V.

It is to be noted that in the case where the unit delay amount d is one frame time period for the video signal, the video delaying unit 117 may receive not the amount of delay D itself, but a set value which is multiplied by the unit delay amount d. For example, when the set value is “+12”, the video delaying unit 117 which has received the set value determines the video delay amount V to be “+12”, and delays the video signal by 12 frames as described above.

As a result, the output of the video signal from the video output unit 111 to the display 150 is delayed by “200 msec” which is the same as the audio delay amount D.

As described above, the video delaying unit 117 delays the video signal by the video delay amount V according to the audio delay amount D. As a result, a time of outputting the audio from the headphone 200 and a time of displaying the video on the display 150 match.

Here, in this embodiment, the above processing for delaying the video signal by the video delaying unit 117 is also performed during the operation in the adjustment mode. That is, timing in which the ball displayed on the user interface screen 151 touches the floor shown in FIG. 4 varies corresponding to a variation of the timing of outputting the pulsed sound from the speaker 160.

It is to be noted that the processing for delaying the video signal may be performed by the video delaying unit 117 at least during the time period in which the operation mode of the video-audio processing device 110 is the viewing and listening mode. That is, the video corresponding to the audio for the synchronization adjustment (for example, the video of the ball in FIG. 4) which is outputted from the speaker 160 and the headphone 200 in the adjustment mode need not be displayed on the user interface screen 151.

Moreover, the user interface screen 151 may be displayed in a part of a display area of the display 150. For example, user interface video necessary for entering and confirming the set value, that is, the set value display field 152 for example, may be displayed by being superimposed on video of a normal broadcast program. In this case, the audio of the broadcast program may be used as the audio for the synchronization adjustment.

Moreover, the user interface screen 151 is not essential, but the user may be informed of that the operation is the adjustment mode via an image displayed on the display 150, a lump provided for the television 100, or audio from the speaker 160.

In this case, being able to recognize that the operation is the adjustment mode, the user can delay the audio from the speaker 160 so as to synchronize the audio from the speaker 160 with the audio from the headphone 200 by operating on the arrow key on the remote controller 170, for example.

Moreover, the switching from the adjustment mode to the viewing and listening mode is triggered by, for example, a press on the predetermined button of the remote controller 170 for determining the set value as described above. Moreover, for example, the switching from the adjustment mode to the viewing and listening mode may be triggered by that the time period in which the delay information (set value) received by the receiving unit 115 is not changed exceeds a threshold value.

When the operation mode of the video-audio processing device 110 is switched to the viewing and listening mode, the user can watch the video delayed as described above on the display 150.

Specifically, the video delayed by the amount of delay between the actual output timing and the original output timing of the audio outputted from the headphone 200 is displayed on the display 150. As a result, the reproduced audio from the headphone 200 and the reproduced video displayed on the display 150 is synchronized.

It is to be noted that when the operation mode of the video-audio processing device 110 is the viewing and listening mode, the audio output from the speaker 160 need not be stopped, but may be continued. In this case, the audio delaying unit 116 may delay the output of the audio signal from the audio output unit 112 by the audio delay amount D (or the video delay amount V) as above, for example.

With this, it is possible to allow a user who does not wear the headphone 200 to view and listen to the AV content viewed and listened to by a user wearing the headphone 200. That is, it is possible to provide the user who does not wear the headphone 200 with the audio synchronized with the reproduced video displayed on the display 150, by means of the speaker 160.

Moreover, when communication between the video-audio processing device 110 and the headphone 200 is ended, for example, the video-audio processing device 110 is switched from the viewing and listening mode to the normal mode, triggered by the end of the communication. Moreover, the video delaying unit 117 ends the delay processing for the video signal.

As described above, in the video-audio processing device 110 according to this embodiment, the amount of delay between the actual output timing and the original output timing of the audio outputted from the headphone 200 is determined based on the comparison between the audio from the speaker 160 and the audio from the headphone 200 in the synchronization adjustment.

That is, it is not that video itself which should be synchronized with the reproduced audio from the headphone 200 is used but the output audio from the speaker 160 which is reliably synchronized with the video is used as a target for comparison with the reproduced audio from the headphone 200, and thus, the amount of delay of the video is determined.

Thus, according to the video-audio processing device 110 in this embodiment, synchronization between video signal and audio signal in reproduction can be efficiently performed.

It is to be noted that, in the above description, one frame time period calculated from the frame rate of the video signal is used as the unit delay amount d. However, the unit delay amount d is not specifically limited, but, for example, may be smaller than the one frame time period for the video signal treated by the video-audio processing device 110.

With this, for example, it is possible to increase exactness of the value inputted to the video-audio processing device 110 as the delay information. That is, a more exact value can be determined as the audio delay amount D for the synchronization adjustment.

Here, in the case where a value smaller than the one frame time period is employed as the unit delay amount d as described above, the audio delay amount D may be different from an integral multiple of the one frame time period.

That is, even in the case where an accurate value for an exact synchronization is determined as the audio delay amount D, the reproduced audio from the headphone 200 and the reproduced video displayed on the display 150 do not exactly synchronize with each other when the video delaying unit 117 delays the video signal on a per frame basis as described above.

Therefore, the video delaying unit 117 may delay the video signal not on a per frame basis, but in units smaller than the one frame time period. This enables more exact synchronization between the reproduced audio from the headphone 200 and the reproduced video on the display 150.

Moreover, when the delay of the video signal on a per frame basis is maintained, for example, in order not to increase the processing load of the video delaying unit 117 for the video delay, the video delay amount V may be determined to be smaller than the audio delay amount D. With this, at least, a very unnatural situation in which the reproduced audio from the headphone 200 precedes the reproduced video displayed on the display 150 is prevented.

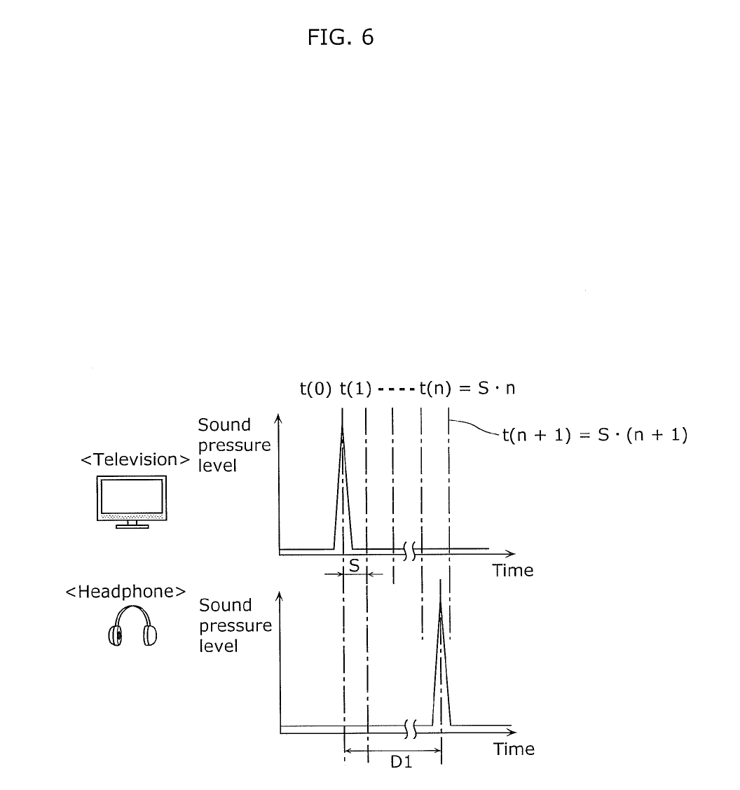

FIG. 6 is a diagram showing a relationship of one frame time period S and an amount of delay between audio output timings of the speaker 160 and the headphone 200.

For example, it is assumed that an amount of exact temporal delay between the audio from the speaker 160 and the audio from the headphone 200 is D1. In this case, since the audio from the speaker 160 and the reproduced video on the display 150 is synchronized, the amount of exact temporal delay between the reproduced video on the display 150 and the audio from the headphone 200 is also assumed to be D1.

Here, it is assumed that delay information which indicates the D1 as the audio delay amount is inputted to the video-audio processing device 110.

In this assumption, when the video delaying unit 117 delays the video signal on a per frame basis, the video delay amount V is an integral multiple of the one frame time period S. That is, in FIG. 6, when t(0) is an origination (video delay amount=0), any one of t(0), t(1) . . . t(n+1) . . . is determined as the video delay amount V, where t(n)=S·n (n is a positive integer).

In this case, for example, the controlling unit 114 or the video delaying unit 117 determine a value smaller than or equal to the audio delay amount D1 indicated by the delay information as the video delay amount V.

In the case shown in FIG. 6, t(n) which is smaller than or equal to the audio delay amount D1, is closest to the audio delay amount D1, and is an n-multiple of the one frame time period S is determined as the video delay amount V.

For example, when the audio delay amount D1 is 210 msec and the one frame time period S is (50/3) msec, “200 msec” which is smaller than or equal to 210 msec, is closest to 210 msec, and 12 times as large as (50/3) msec is determined as the video delay amount V. It is to be noted that, in this case, “12” which is the number of frames corresponding to “200 msec” may be determined as the video delay amount V as described above.

As described above, when the audio delay amount D indicated by the delay information inputted to the video-audio processing device 110 is an integral multiple of a constant, the audio delay amount D can be closer to the original amount of delay for the lip-sync as the constant is smaller. That is, the exactness of the audio delay amount D can be increased.

Moreover, when the video delay amount V cannot be equal to the highly exact audio delay amount D, for example, when the video delay amount V is an integral multiple of one frame time period, a value smaller than or equal to the audio delay amount D and close to the audio delay amount D is determined as the video delay amount V as described above. With this, the problem in lip-sync between the display 150 and the headphone 200 is substantially prevented, and a very unnatural situation in which audio precedes video is prevented.

Moreover, in the case shown in FIG. 6, a value larger than the audio delay amount D1 may be determined as the video delay amount V. For example, t(n+1) which is closest to the audio delay amount D1 and is an integral multiple of the one frame time period S may be determined as the video delay amount V.

In this case, for example, the reproduced audio from the headphone 200 and the reproduced video on the display 150 can be synchronized by delaying transmission of the audio signal from the audio transmitting unit 113 to the headphone 200.

For example, it is assumed that, when the audio delay amount D1 is 186 msec and the one frame time period S is (50/3) msec, “200 msec” which is larger than 186 msec and is an integral multiple of (12 times as large as) (50/3) msec is determined as the video delay amount V.

In this case, since the video delay amount V is larger than the audio delay amount D1 by 14 msec, the reproduced audio from the headphone 200 precedes the reproduced video on the display 150 by 14 msec when no measures are taken.

In this regard, the transmission of the audio signal from the audio transmitting unit 113 to the headphone 200 is delayed by 14 msec.

Thus, when the audio delay amount D1 is equal to the original amount of delay for lip-sync, the reproduced audio from the headphone 200 and the reproduced video on the display 150 are completely synchronized theoretically. Moreover, even when an error in the audio delay amount D1 is considered, the exactness of lip-sync between the headphone 200 and the display 150 is increased.

In short, the video-audio processing device 110 is also capable of exactly synchronizing the reproduced audio from the headphone 200 and the reproduced video on the display 150 by increasing the video delay amount more than the originally necessary amount and delaying the audio for the headphone 200.

Moreover, the video delay amount V which is used for the synchronization adjustment in the video-audio processing device 110 as described above may be stored.

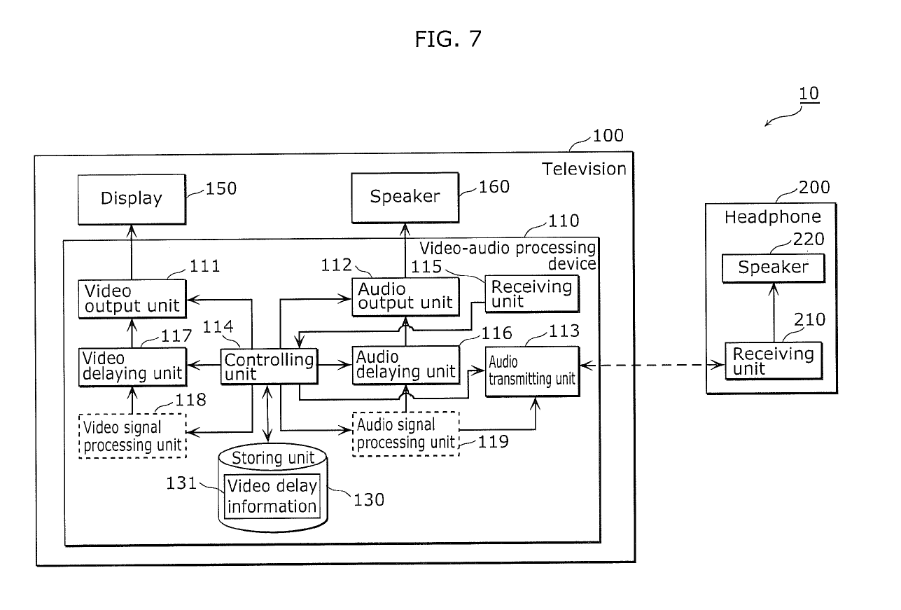

FIG. 7 is a block diagram showing a basic functional configuration of the video-audio processing device 110 according to the embodiment in the case where the video-audio processing device 110 includes a storing unit 130.

For example, the controlling unit 114 in the video-audio processing device 110 stores the video delay amount V determined in the above synchronization adjustment in the storing unit 130 as video delay information 131.

With this, when the communication between the headphone 200 and the video-audio processing device 110 is once stopped and then resumed, an automatic synchronization adjustment is performed using the stored video delay amount V. That is, the controlling unit 114 reads out the video delay amount V from the storing unit 130 and transmits the read video delay amount V to the video delaying unit 117 to cause the video delaying unit 117 to delay the video signal according to the video delay amount V.

It is to be noted that the video delay information 131 stored in the storing unit 130 need not indicate the video delay amount V itself. For example, the video delay information 131 indicating the audio delay amount D corresponding to the video delay amount V may be stored in the storing unit 130.

Moreover, when the video-audio processing device 110 communicates with plural audio reproduction devices, the storing unit 130 may store therein the video delay information 131 indicating plural video delay amounts which respectively correspond to the audio reproduction devices.

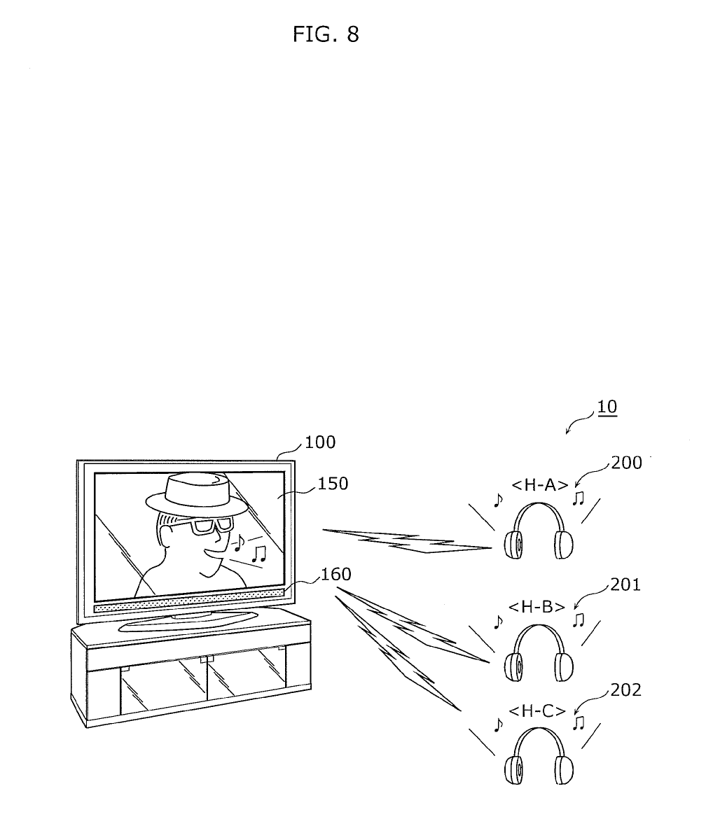

FIG. 8 is a diagram showing a schematic configuration of the AV system 10 according to the embodiment in the case where the AV system 10 includes plural audio reproduction devices.

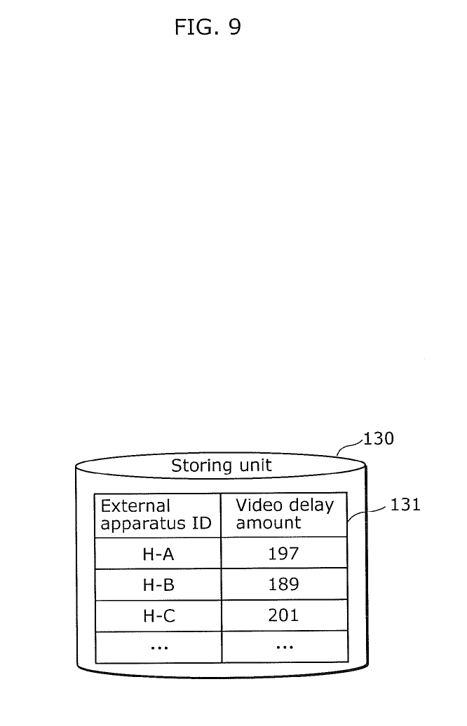

FIG. 9 is a diagram showing an example of a data configuration of the video delay information 131 according to the embodiment.

As shown in FIG. 8, it is assumed that the television 100 including the video-audio processing device 110 communicates with two headphones (201, 202) in addition to the above headphone 200.

It is to be noted that, for each of the headphones 201 and 202, the synchronization adjustment described with reference to FIGS. 3 to 5 has been performed after a pairing with the video-audio processing device 100 is completed, for example. That is, video delay amounts V respectively corresponding to the headphones 201 and 202 have been determined.

Moreover, each of the three headphones (200, 201, and 202) have a different amount of delay between the actual reproduction timing and the original reproduction timing of the audio due to a difference in models or individual variability.

Therefore, as shown in FIG. 9, the video delay information 131 indicating the video delay amounts V respectively corresponding to the three headphones (200, 201, and 202) is stored in the storing unit 130 in such a manner that external apparatus IDs which are identifiers of the headphones and the video delay amounts V are associated. It is to be noted that the video-audio processing device 110 is informed of the external apparatus IDs of the headphones (200, 201, and 202) from each of the headphones (200, 201, and 202) when the communication between each headphone and the video-audio processing device 110 is started.

Moreover, in the example shown in FIG. 9, the external apparatus ID of the headphone 200 is “H-A”, the external apparatus ID of the headphone 201 is “H-B”, and the external apparatus ID of the headphone 202 is “H-C”.

By storing the video delay information 131 including such information in the storing unit 130, the video-audio processing device 110 is capable of performing delay processing for the video signal using an appropriate video delay amount even when a headphone to which the audio signal is transmitted is changed.

Here, there may be the case where at least two of the three headphones (200, 201, and 202) simultaneously communicate with the video-audio processing device 110.

For example, it is assumed that each of three users wears one of the headphones (200, 201, and 202) and watches video displayed on the display 150 of the television 100.

In this case, the video delaying unit 117 in the video-audio processing device 110 performs the following processing. That is, when the operation mode is the viewing and listening mode and the audio transmitting unit 113 transmits the audio signal to three headphones (200, 201, and 202) simultaneously, the video delaying unit 117 (a) selects the largest video delay amount V among the video delay amounts V indicated by the video delay information 131 stored in the storing unit 130 and (d) delays the output of the video signal from the video output unit 111 by the selected video delay amount V.

For example, when the video delay amounts respectively corresponding to three headphones (200, 201, and 202) have values shown in FIG. 9, “201 msec” corresponding to the headphone 202 is employed as the video delay amount V used by the video delaying unit 117.

That is, when there are plural apparatuses to which the audio signal is transmitted, the video-audio processing device 110 delays the output of the video signal from the video-audio processing device 110 by an amount corresponding to the largest audio delay amount among the audio delay amounts for the apparatuses.

Thus, at least, a very unnatural situation in which the reproduced audio from each of the headphones (200, 201, and 202) precedes the reproduced video displayed on the display 150 is prevented.

Moreover, in this case, the audio transmitting unit 113, for example, may delay the transmission of the audio signal to each of the headphones 200 and 201. With this, the video displayed on the display 150 and the reproduced audio from each of the headphones 200 and 201 can be more exactly synchronized.

For example, as described above, it is assumed that “201 msec” is employed as the video delay amount V used by the video delaying unit 117. In this case, the audio transmitting unit 113 delays the audio signal by 4 msec for the headphone 200 corresponding to the video delay amount V “197 msec”.

Moreover, the audio transmitting unit 113 delays the audio signal by 12 msec for the headphone 200 corresponding to the video delay amount V “189 msec”.

That is, the transmission of the audio signal to each of the headphones 200 and 201 is delayed so as to match the video delay amount V which has been set to be larger than the video delay amounts required by the headphones 200 and 201. With this, a problem in lip-sync is more reliably resolved for all of the three headphones (200, 201, and 202).

Moreover, the delay information need not be inputted to the video-audio processing device 110 via the user interface screen 151. For example, the reproduced audio signal representing the reproduced audio from the headphone 200 may be inputted to the video-audio processing device 110 as the delay information.

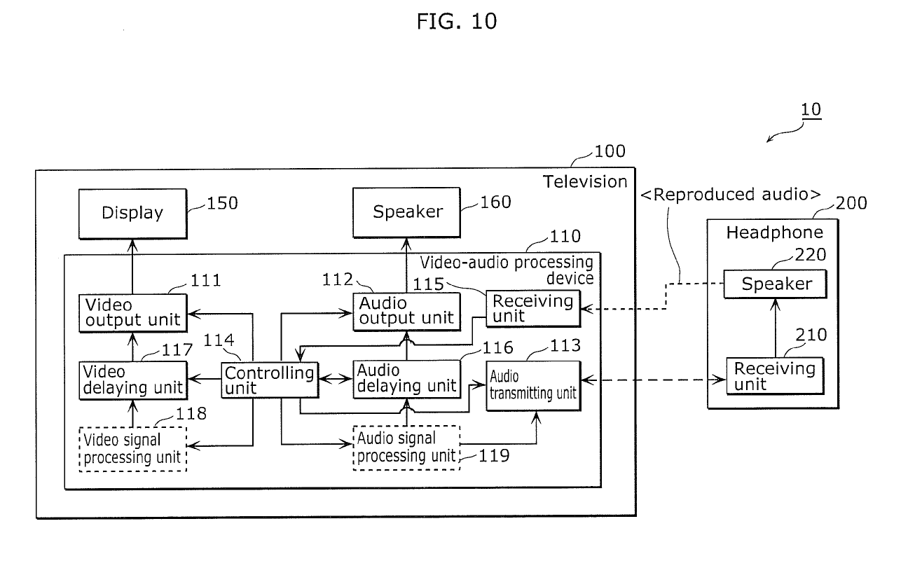

FIG. 10 is a block diagram showing a basic functional configuration of the video-audio processing device 110 according to the embodiment in the case where the video-audio processing device 110 obtains the reproduced audio signal as the delay information.

As shown in FIG. 10, the reproduced audio signal representing the reproduced audio from the headphone 200 is received by the receiving unit 115 as the delay information.

For example, the reproduced audio signal is inputted to the receiving unit 115 via a microphone (not shown) connected to the receiving unit 115. Otherwise, the reproduced audio signal is inputted to the receiving unit 115 via an audio input terminal (not shown) connected to the receiving unit 115.

In this case, the controlling unit 114, for example, determines the audio delay amount D from a temporal difference between the time of a peak of a sound level indicated by the audio signal outputted from the audio delaying unit 116 and the time of a peak of a sound level indicated by the audio signal inputted to the reproduced audio signal.

It is to be noted that a method of determining the audio delay amount D using the two signals is not limited to the above method. Moreover, the audio delay amount D may be determined not by the controlling unit 114, but by the audio delaying unit 116 or the receiving unit 115, for example.

Moreover, the determination of the audio delay amount D may be performed through the above comparison processing for one time. Moreover, the determination of the audio delay amount D may be performed through a feedback of the amount of delay between the audio signal outputted from the audio delaying unit 116 and the reproduced audio signal, while the audio delaying unit 116 varies the amount of delay of the audio signal.

Moreover, although Bluetooth (registered trademark) is employed as a communication standard between the video-audio processing device 110 and the headphone 200 in this embodiment, a communication standard other than Bluetooth (registered trademark) may be employed as the communication standard. Moreover, not wireless communication but wire communication may be used between the video-audio processing device 110 and the headphone 200.

That is, when a delay which is perceivable by a human is generated between the reproduced audio from the headphone 200 and the reproduced video on the display 150 due to a procedure employed by the communication standard, the synchronization adjustment performed by the video-audio processing device 110 is effective irrespective of the kind of the communication standard.

Moreover, the video-audio processing device 110 may be provided for an apparatus other than the television 100. For example, the video-audio processing device 110 may be provided for a recorder or a player which reproduces AV content stored in a hard disk or an optical disk such as Blu-ray Disc (registered trademark).

Moreover, the apparatus to which the audio signal is transmitted from the video-audio processing device 110 may be an audio reproduction device other than the headphone 200.

For example, the audio signal from the video-audio processing device 110 may be transmitted to a surround system which has plural speakers and communicates with the video-audio processing device 110 through wireless or wire communication. That is, the audio reproduction device which generates the audio on which the video-audio processing device 110 performs the synchronization adjustment is not limited to a headphone.

Moreover, each of the structural elements in each of the above-described embodiments may be configured in the form of an exclusive hardware product, or may be realized by executing a software program suitable for the structural element. Each of the structural elements may be realized by means of a program executing unit, such as a central processing unit (CPU) and a processor, reading and executing the software program recorded on a recording medium such as a hard disk or a semiconductor memory. Here, the software program for realizing the video-audio processing device according to the above embodiment is a program described below.

That is, the program causes a computer to execute the following video-audio processing method.

The video-audio processing method executed by a video-audio processing device, in which the video-audio processing device includes a video output unit which outputs a video signal, an audio output unit which outputs an audio signal corresponding to the video signal, and an audio transmitting unit which transmits the audio signal corresponding to the video signal to an external audio reproduction device provided outside the video-audio processing device, and the video-audio processing method includes: receiving an input of delay information indicating an audio delay amount which is an amount for delaying an output of the audio signal from the audio output unit, during a period in which an operation mode of the video-audio processing device is a first mode in which the audio signal is outputted from the audio output unit and the audio signal is transmitted from the audio transmitting unit; delaying the output of the audio signal from the audio output unit according to the audio delay amount indicated by the delay information received in the receiving; and delaying an output of the video signal from the video output unit by a video delay amount that is in accordance with the audio delay amount, during a period in which the operation mode of the video-audio processing device is a second mode in which the video signal is outputted from the video output unit and the audio signal is transmitted from the audio transmitting unit.

The embodiment has been described above as an example of techniques in the present disclosure. For this purpose, the appended drawings and the detailed descriptions are provided.

Thus, the constituent elements described in the accompanying drawings and the detailed descriptions include not only constituent elements essential to solve the technical problem but constituent elements that are inessential to solve the technical problem. Therefore, the inessential constituent elements should not be regarded as essential only because the constituent elements are described in the appended drawings and the detailed descriptions.

Moreover, since the above embodiment is for illustrating the technique in the present disclosure, various modifications, replacements, additions, omissions, and others are possible within the scope of the Claims and their equivalents.

### INDUSTRIAL APPLICABILITY

The present disclosure is useful as a video-audio processing device provided for AV equipment such as a television which reproduces AV content transmitted through broadcasting waves or a network, and a recorder or a player which reproduces AV content stored in a recording medium including an optical disk such as Blu-ray Disc (registered trademark), a semiconductor memory such as a flash memory, or a hard disk.

### REFERENCE SIGNS LIST

10 AV system
100 Television
110 Video-audio processing device
111 Video output unit
112 Audio output unit
113 Audio transmitting unit
114 Controlling unit
115 Receiving unit
116 Audio delaying unit
117 Video delaying unit
118 Video signal processing unit
119 Audio signal processing unit
130 Storing unit
131 Video delay information
150 Display
151 User interface screen
152 Set value display field
160, 220 Speaker
170 Remote controller
200, 201, 202 Headphone
210 Receiving unit

1. A video-audio processing device comprising:
a video output unit configured to output a video signal;
an audio output unit configured to output an audio signal corresponding to the video signal;
an audio transmitting unit configured to transmit the audio signal corresponding to the video signal to an external audio reproduction device provided outside the video-audio processing device;
a controlling unit configured to switch an operation mode of the video-audio processing device between (a) a first mode in which the audio signal is outputted from the audio output unit and the audio signal is transmitted from the audio transmitting unit and (b) a second mode in which the video signal is outputted from the video output unit and the audio signal is transmitted from the audio transmitting unit;
a receiving unit configured to receive an input of delay information indicating an audio delay amount which is an amount for delaying an output of the audio signal from the audio output unit, during a period in which the operation mode is the first mode;
an audio delaying unit configured to delay the output of the audio signal from the audio output unit according to the audio delay amount indicated by the delay information received by the receiving unit; and
a video delaying unit configured to delay an output of the video signal from the video output unit by a video delay amount that is in accordance with the audio delay amount, during a period in which the operation mode is the second mode.

2. The video-audio processing device according to claim 1,
wherein the video output unit is configured to output a video signal representing a user interface screen for a predetermined operation by a user, during a period in which the operation mode is the first mode, and
the receiving unit is configured to receive an input of the delay information inputted through the predetermined operation by the user.

3. The video-audio processing device according to claim 1,
wherein the video delaying unit is configured to delay the output of the video signal from the video output unit by the video delay amount which is smaller than or equal to the audio delay amount.

4. The video-audio processing device according to claim 1,
wherein the audio delaying unit is configured to delay the output of the audio signal from the audio output unit according to the audio delay amount which corresponds to an integral multiple of a time period for one frame calculated from a frame rate of the video signal.

5. The video-audio processing device according to claim 1,
wherein the video delaying unit is configured to delay the output of the video signal from the video output unit by the video delay amount which is larger than the audio delay amount, and
the audio transmitting unit is configured to delay transmission of the audio signal from the audio transmitting unit by a value corresponding to a difference between the audio delay amount and the video delay amount.

6. The video-audio processing device according to claim 1,
wherein the video delaying unit is configured to delay the output of the video signal from the video output unit by the video delay amount which is smaller than or equal to the audio delay amount and corresponds to an integral multiple of a time period for one frame calculated from a frame rate of the video signal.

7. The video-audio processing device according to claim 1,
wherein the receiving unit is configured to receive, as the delay information, an input of a reproduced audio signal which is an audio signal outputted from the external audio reproduction device which receives and reproduces the audio signal, and
the video delaying unit is configured to delay the output of the video signal from the video output unit by the video delay amount that is in accordance with the audio delay amount which is an amount of delay between the reproduced audio signal and the audio signal that has not yet been delayed by the audio delaying unit.

8. The video-audio processing device according to claim 1, further comprising
a storing unit configured to store therein video delay information which is information indicating the video delay amount,
wherein the video delaying unit is configured to delay the output of the video signal from the video output unit by the video delay amount indicated by the video delay information read from the storing unit, during a period in which the operation mode is the second mode.

9. The video-audio processing device according to claim 8,
wherein the storing unit is configured to store therein the video delay information indicating plural video delay amounts respectively corresponding to plural audio reproduction devices including the audio reproduction device, and
when the operation mode is the second mode and the audio transmitting unit simultaneously transmits the audio signal to each of the audio reproduction devices, the video delaying unit is configured to (c) select the largest video delay amount among the video delay amounts indicated by the video delay information stored in the storing unit and (d) delay the output of the video signal from the video output unit by the selected video delay amount.

10. A video-audio processing method executed by a video-audio processing device,
wherein the video-audio processing device includes a video output unit which outputs a video signal, an audio output unit which outputs an audio signal corresponding to the video signal, and an audio transmitting unit which transmits the audio signal corresponding to the video signal to an external audio reproduction device provided outside the video-audio processing device, and
the video-audio processing method comprises:
receiving an input of delay information indicating an audio delay amount which is an amount for delaying an output of the audio signal from the audio output unit, during a period in which an operation mode of the video-audio processing device is a first mode in which the audio signal is outputted from the audio output unit and the audio signal is transmitted from the audio transmitting unit;
delaying the output of the audio signal from the audio output unit according to the audio delay amount indicated by the delay information received in the receiving; and
delaying an output of the video signal from the video output unit by a video delay amount that is in accordance with the audio delay amount, during a period in which the operation mode of the video-audio processing device is a second mode in which the video signal is outputted from the video output unit and the audio signal is transmitted from the audio transmitting unit.
